(19) United States
(12) Patent Application Publication
(10) Pub. No.: US 2023/0364851 A1
(43) Pub. Date: Nov. 16, 2023

(54) METHOD OF THERMOFORMING MULTILAYER POLYMER FILM AND ARTICLES

(71) Applicant: 3M INNOVATIVE PROPERTIES COMPANY, St. Paul, MN (US)

(72) Inventors: Anthony F. Schultz, Forest Lake, MN (US); Ta-Hua Yu, Woodbury, MN (US); Duane D. Fansler, Dresser, WI (US); Karl J.L. Geisler, St. Paul, MN (US); Bruce R. Broyles, Oakdale, MN (US); Bhaskar V. Velamakanni, Woodbury, MN (US); THomas J. Metzler, St. Paul, MN (US); Jonathan E. Janoski, Woodbury, MN (US); Richard J. Pokomy, Maplewood, MN (US); Mark T. Gibson, Stillwater, MN (US); Ahmed S. Abuelyaman, Woodbury, MN (US)

(21) Appl. No.: 18/246,064

(22) PCT Filed: Oct. 26, 2021
(86) PCT No.: PCT/IB2021/059900

§ 371 Date: Mar. 21, 2023

Related U.S. Application Data
(60) Provisional application No. 63/107,092, filed on Oct. 29, 2020.

(51) Int. Cl. B29C 51/14

(52) U.S. Cl. CPC B29C 51/14; B29K 2033/12

(57) ABSTRACT

A method of thermoforming is described. The method comprises providing a multilayer polymer film comprising at least one first thermoplastic polymer layer having a glass transition temperature (Tg) greater than 60° C. and at least one second polymer layer; and thermoforming the multilayer polymer film into a three-dimensional shape. The second polymer layer can be characterized by one or more properties selected from i) a Tg ranging from 20 to 70° C.; ii) a molecular weight between crosslinks of no greater than 20,000 g/mole; and iii) sufficient crosslinking such that the second polymer layer lacks a thermal melt or softening transition at a temperature up to the decomposition temperature of the second polymer layer. Also described are multilayer films and articles, such as orthodontic aligner and retainer trays.

### SUMMARY

In one embodiment, a method of thermoforming is described. The method comprises providing a multilayer polymer film comprising at least one first thermoplastic polymer layer having a glass transition temperature (Tg) greater than 60° C. and at least one second polymer layer; and thermoforming the multilayer polymer film into a three-dimensional shape. The second polymer layer can be characterized by one or more properties selected from i) a Tg ranging from 20 to 70° C.; ii) a molecular weight between crosslinks of no greater than 20,000 g/mole; and iii) sufficient crosslinking such that the second polymer layer lacks a thermal melt or softening transition at a temperature up to the decomposition temperature of the second polymer layer.

In some embodiments, the first thermoplastic polymer layer is a polyester and the second polymer layer comprises a (meth)acrylic polymer. The meth(acrylic) polymer may further comprise polyvinyl acetal polymer.

In another embodiment, a multilayer polymer film for use for thermoforming is described comprising at least one first thermoplastic polymer layer having a glass transition temperature (Tg) greater than 70° C. and at least one second polymer layer characterized by the one or more Tg and/or crosslinking properties described above.

In another embodiment, a multilayer polymer film is described comprising at least one first and third thermoplastic polymer layer, independently having a glass transition temperature (Tg) greater than 70° C. and at least one second polymer layer disposed between the first and third thermoplastic layer characterized by the one or more Tg and/or crosslinking properties described above.

In another embodiment, an article is described comprising a (e.g. thermoformed) multilayer polymer film comprising at least one first thermoplastic polymer layer having a glass transition temperature (Tg) greater than 70° C. and at least one second polymer layer characterized by the one or more Tg and/or crosslinking properties described above. In some embodiments, the article is a dental appliance for positioning a patient’s teeth.

Articles such as orthodontic aligner and retainer trays can be manufactured by thermoforming a polymeric film to provide a plurality of tooth-retaining cavities therein. In some cases. the thermoforming process can thin regions of a relatively rigid polymeric film selected to efficiently apply tooth repositioning force over a desired treatment time. This undesirable thinning can cause localized cracking of the thermoformed dental appliance when the patient repeatedly places the dental appliance over the teeth. Undesirable thinning causing localized cracking can also be a problem with other thermoformed (e.g. three-dimensional) articles.

As described for example in International application no. PCT/IB2020/054051 an orthodontic dental appliance made from a relatively stiff polymeric material with a high flexural modulus selected to effectively exert a stable and consistent repositioning force against the teeth of a patient such as, for example, polyesters and polycarbonates, can cause discomfort when the dental appliance repeatedly contacts oral tissues or the tongue of a patient over an extended treatment time. These high modulus polymeric materials can also have poor stress retention behavior to provide a desired level of force persistence performance. A rubbery elastomer has excellent stress retention behavior, but in many cases may be too soft to be used alone in a dental appliance to effectively move teeth into a desired alignment condition in a reasonably short treatment time.

Thus, industry would find advantage in methods of thermoforming, thermoformable multilayer films, and articles that provide improved properties, such as reduced localized cracking and/or improved tear strength due to thinning during thermoforming and/or improved flexural modulus properties.

### BRIEF DESCRIPTION OF DRAWINGS

FIG. 1 is a schematic overhead perspective view of an embodiment of a multilayered dental appliance.

FIGS. 2A-2C are schematic, cross-sectional view of an embodiment of a multilayered dental appliance of FIG. 1.

FIG. 3 is a schematic, cross-sectional view of an embodiment of a multilayered dental appliance of FIG. 1.

FIG. 4 is a schematic overhead perspective view of a method for using a dental alignment tray by placing the dental alignment tray to overlie teeth.

### DETAILED DESCRIPTION

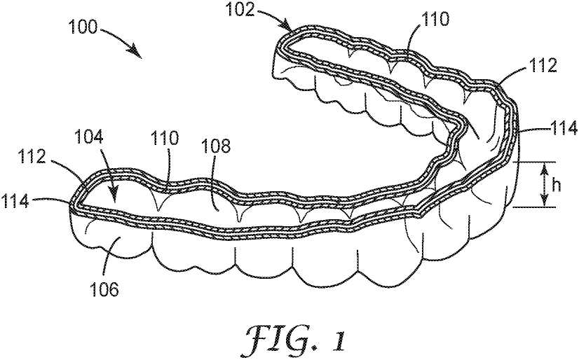

FIG. 1 depicts a representative (e.g. thermoformed) article, an orthodontic appliance 100, also referred to herein as an orthodontic aligner tray. Orthodontic appliance 100 includes a thin polymeric shell 102 having a plurality of cavities 104 shaped to receive one or more teeth in the upper or lower jaw of a patient. In some embodiments, in an orthodontic aligner tray the cavities 104 are shaped and configured to apply force to the teeth of the patient to resiliently reposition one or more teeth from one tooth arrangement to a successive tooth arrangement In the case of a retainer tray, the cavities 104 are shaped and configured to receive and maintain the position of one or more teeth that have previously been aligned.

The shell 102 of the orthodontic appliance 100 is an arrangement of layers of elastic polymeric materials that generally conforms to a patient’s teeth, and may be transparent, translucent, or opaque. The polymeric materials are selected to provide and maintain a sufficient and substantially constant stress profile during a desired treatment time, and to provide a relatively constant tooth repositioning force over the treatment time to maintain or improve the tooth repositioning efficiency of the shell 102.

Other thermoformed thin “polymeric shells” can have other three-dimensional shapes, such as the shape of a medical or non-medical face mask. In some embodiments, the polymeric shell is a packaging article.

In the embodiment of FIG. 1, an arrangement of one or more polymeric layers 114, which also may be referred to herein as skin layers, forms an external surface 106 of the shell 102. The first major (e.g. external) surface 106 contacts the tongue and cheeks of a patient. An arrangement of one or more polymeric layers 110, which may also be referred to herein as skin layers, forms a second major (e.g. internal) surface 108 of the shell 102. The internal surface 108 contacts the teeth of a patient. An arrangement of internal polymeric layers 112 can reside between the polymeric layers 110 and 114. The thickness of the polymeric shell is orthogonal to the first and second major surface.

The thermoformed polymeric shell has a three-dimensional shape having an average height, “h” (relative to a planar reference plane) of at least 1, 2, 3, 4, 5, 6, 7, 8, 9, or 10 mm. The average height is significantly greater than the thickness of the multilayer film from which it was formed. For example, the thickness of the film can be 1 mm or less, whereas the height of the polymeric shell can be at least 2X (e.g. 2 mm), 3X, 4X, 5X, 6X, 7X, 8X, 9X or 10X the thickness of the unformed multilayer film.

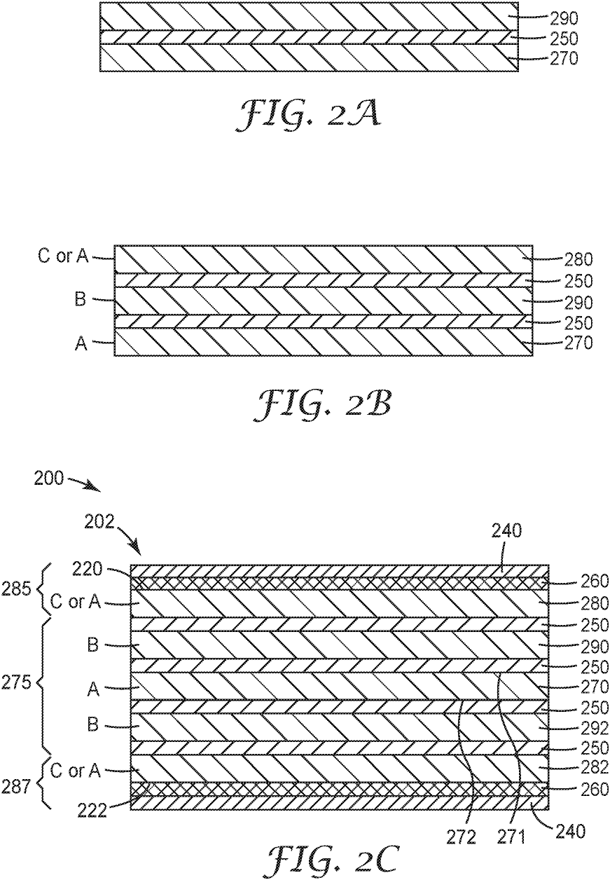

Schematic cross-sectional views of some embodied multilayer films for use for thermoforming and thermoformed articles are shown in FIGS. 2A-2C.

In FIG. 2A, the multilayer films for use for thermoforming and thermoformed articles have a first thermoplastic polymer layer, subsequently describe as thermoplastic polymer A, having a glass transition temperature (Tg) greater than 60° C. and at least one second polymer layer, subsequently described as polymer B. In this embodiment, the second polymer layer, subsequently described as polymer B, is either an external polymeric layer or internal polymeric layer. In the case of orthodontic appliance 100, the external polymeric layer may contact the tongue and cheeks of a patient or may contact the teeth of a patient, as described above. In the case of other medical articles, such as face masks, second polymer layer, subsequently described as polymer B, may contact the face or may be the external polymeric layer.

In FIG. 2A, the multilayer films for use for thermoforming and thermoformed articles have a first and third thermoplastic polymer layer, independently having a glass transition temperature (Tg) greater than 60° C. and at least one second polymer layer, subsequently described as polymer B. The first thermoplastic polymer layer is subsequently described as thermoplastic polymer A. The second thermoplastic layer can be thermoplastic polymer A or thermoplastic polymer C as will subsequently be described. In this embodiment, the second polymer layer, subsequently described as polymer B, is disposed between the first and second polymer layers. Thus, the second layer of polymer B is an internal polymeric layer.

In FIGS. 2A and 2B, the second polymer layer may be disposed upon the first thermoplastic polymer layer. Optionally, the first and second layer may optionally comprise a tie layer (as shown), primer layer, or adhesion promoting (e.g. corona) surface treatment between the first and second layer to improve adhesion.

A schematic cross-sectional view of an embodiment of a (e.g. dental appliance) article 200 is shown in FIG. 2C, which includes a polymeric shell 202 with a multilayered polymeric structure. The polymeric shell 202 includes at least 3, or at least 5, or at least 7, alternating layers of thermoplastic polymers AB. The polymeric shell 202 includes an interior region 275 including a core layer 270 with a first major surface 271 and a second major surface 272. The interior region 275 further includes interior layers 290, 292 arranged on the first major surface 271 and the second major surface 272, respectively, of the core layer 270. The polymeric shell further includes exterior regions 285, 287 on opposed sides of the interior region 275. The exterior regions, which may also be referred to herein as skin layers, include first and second external surface layers 280, 282, which face outwardly on the exposed surfaces of the polymeric shell 202. Such dental appliance includes at least 5 polymeric layers, with softer polymeric interior layers disposed between a harder polymeric core layer and two harder polymeric outer layers. The harder core layer can enhance dimensional stability, while the softer middle layers positioned close to the outer skin layers can improve patient comfort and strain recovery. Optional layers 240 and 260 are subsequently described.

The thermoplastic polymer A can include any thermoplastic polymer. The most common thermoplastics used in the thermoforming are acrylic (PMMA), acrylonitrile butadiene styrene (ABS), cellulose acetate, polyolefins such as low density polyethylene (LDPE), high density polyethylene (HDPE), polypropylene (PP), polystyrene (PS), polyvinyl chloride (PVC), polyesters, and polyamides including nylons. All of these classes include polymers that can be melted, formed into films, and re-shaped via thermoforming into different forms.

In some embodiments, thermoplastic polymer A may include a polyester or a copolyester, which may include linear, branched or cyclic segments on the polymer backbone. Suitable polyesters and copolyesters may include ethylene glycol on the polymer backbone or may be free of ethylene glycol. Suitable polyesters include, but are not limited to, copolyesters with no ethylene glycol available under the trade designation TRITAN from Eastman Chemical, Kingsport, TN, polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedimethylene) terephthalate (PCTA), polycarbonate (PC), and mixtures and combinations thereof. Suitable PETg resins, which contain no ethylene glycol on the polymer backbone, can be obtained from various commercial suppliers such as, for example, Eastman Chemical, Kingsport, TN; SK Chemicals, Irvine, CA; DowDuPont, Midland, MI; Pacur, Oshkosh, WI; and Scheu Dental Tech, Iserlohn, Germany. For example, EASTAR GN071 PETg resins and PCTg VM318 copolyester resins from Eastman Chemical have been found to be suitable. Copolyester materials can be preferred for medical articles, such as dental appliances.

The following table depicts properties of various thermoplastic polymers suitable for thermoplastic polymer A of the first layer.

TABLE A

| | Tg | Vicat Softening Temp. | Flexural Modulus | Elongation at Break |
|---|---|---|---|---|
| PETg | 80-82° C. | 74-85° C. | 2-2.4 GPa | 90-180% |
| PCTg | 81-85° C. | 79-88° C. | 1.7-1.9 GPa | 320-340% |
| TX1000 | 110° C. | 110° C. | 1.55 GPa | 210% |
| MX710 | 110° C. | 110° C. | 1.55 GPa | 210% |
| MX730 | 110° C. | Not Reported | 1.575 GPa | 210% |
| TX2000 | 120° C. | Not Reported | 1.59 GPa | 140% |
| ZEONOR | 100-105° C. | 99-110° C. | 1.9-2.2 GPa | 60-100% |

In some embodiments of FIGS. 2A-2C, first layer 270 includes one or more layers of a thermoplastic polymer A having a glass transition temperature (Tg) (measured by differential scanning calorimeter according to ASTM D3418) of greater than 60, 65, 70, 75, or 80° C. Thermoplastic polymer A typically has a glass transition temperature of no greater than 140, 135, 130, 125 or 120° C.

In some embodiments of FIGS. 2A-2C, first layer 270 includes one or more layers of an (e.g. amorphous) thermoplastic polymer A having a Vicat Softening Temperature (measured according to ASTM D1525 - 17) of greater than 60, 65, 70, 75, or 80° C. Thermoplastic polymer A typically has a Vicat Softening Temperature of no greater than 140, 135, 130, 125 or 120° C.

Notably the Tg of thermoplastic polymer A is typically greater than the Vicat Softening Temperature. Thus, the Vicat Softening Temperature is indicative of the minimum thermoforming temperature. As used herein the term thermal melt or softening transition refers to the Vicat Softening Temperature of an (e.g. amorphous) thermoplastic polymer or the melt temperature (Tm) of a thermoplastic polymer having crystallinity as measured by differential scanning calorimeter according to ASTM D3418.

In some embodiments, the thermoplastic polymer A has an elongation at break of greater than about 100, 150, or 200%. In some embodiments, the thermoplastic polymer A has an elongation at break of no greater than 400, 350, 300, 250, or 200%. In some embodiments of FIGS. 2A-2C, the core layer 270 includes one or more layers of thermoplastic polymer A having a flexural modulus greater than about 1.3 GPa, or greater than about 1.5 GPa, or greater than about 2 GPa.

In some embodiments, the polymeric shell 202 has an overall flexural modulus necessary to move the teeth of a patient. In some embodiments, the polymeric shell 102 has an overall flexural modulus of greater than 0.5, 0.6, 0.7, 0.8, 0.9 or 1 GPa. In some embodiments, the polymeric shell 102 has an overall flexural modulus of no greater than 1.5, 1.4 or 1.3 GPa.

In some embodiments, the solubility parameter of thermoplastic polymer A is at least 8 or 9 cal^{½} cm^{-3/2}. The solubility parameter can be estimated according to the group contribution method outlined in Chapter 3 of Sperling, L. H., Introduction to Physical Polymer Science, John Wiley & Sons, Inc.: Hoboken, New Jersey, 2006. In some embodiments, the inherent viscosity of thermoplastic polymer A is less than 1, 0.9, 0.8, or 0.7 cc/g. In some embodiments, the inherent viscosity of thermoplastic polymer A is at least 0.6 cc/g.

In some embodiments, the interfacial adhesion between any of the adjacent layers in the polymeric shell 202 is greater than about 150 grams per inch (6 grams per mm), or greater than about 500 grams per inch (20 grams per mm).

In one embodiment, the first and second external surface layers 280, 282, which may be the same or different, each include one or more layers of thermoplastic polymer A.

In another embodiment, the first and the second external surface layers 280, 282 may include at least one or more layers of thermoplastic polymer C, a different thermoplastic polymer than thermoplastic polymer A. Thermoplastic polymer C may have a thermal melt or softening transition, flexural modulus, and elongation in the same ranges as previously described for thermoplastic polymer A.

In some embodiments, thermoplastic polymer C may include a polyester or a copolyester, which may be linear, branched, or cyclic. Suitable polyesters include, but are not limited to, the same copolyester materials described for thermoplastic polymer A. In some embodiments, both thermoplastic polymer A and thermoplastic polymer C are the same copolyester materials. In some embodiments, both thermoplastic polymer A and thermoplastic polymer C are copolyester materials, but different copolyester materials.

The multilayer films described herein comprises at least one second layer (e.g. interior layers 290, 292) that comprises a thermoplastic, but more typically a non-thermoplastic polymer having a glass transition temperature (Tg) of at least 5, 10, 15, 20, 25 or 30° C. The Tg of polymer B of the second layer is typically no greater than 70, 65, 60, 55, 50 or 50° C. Notably, the Tg of polymer B of the second layer is greater than thermoplastic polymer B of the interior layers of thermoplastic polymers of previously cited in International application no. PCT/IB2020/054051. Thus, polymer B of the second layer has a different Tg range than typical thermoplastic materials utilized for thermoforming.

The “Dahlquist Criterion for Tack” is widely recognized as a necessary condition of a pressure sensitive adhesives (PSA). It states that a PSA has a shear storage modulus (G′) of less than 3 × 10⁶ dyne/cm² (0.3 MPa) at approximately room temperature (25° C.) and a frequency of 1 Hertz (Pocius, Adhesion and Adhesive Technology 3^{rd} Ed., 2012, p. 288). A shear storage modulus can be converted to a tensile storage modulus using the following equation: E′ = 2G′(r+1), where r is Poisson’s ratio for the relevant material. Using this equation and given that Poisson’s ratio of elastomers and PSAs is close to 0.5, the Dahlquist Criterion expressed as a tensile storage modulus (E′) is less than 0.9 MPa (9 × 10⁶ dyne/cm²).

In some embodiments, (e.g. cured) polymer B of the second layer generally has a tensile storage modulus (E′) at 25° C. of greater than 9 × 10⁶ dynes/cm² (0.9 MPa) at 1 hertz as can be measure by dynamic mechanical analysis (as determined by the test method described in the examples). In other words, when (e.g. cured) polymer B of the second layer has a Tg less than 30 or 25° C. polymer B has a tensile storage modulus (E′) of at least 1 MPa at 25° C. and 1 hertz. In some embodiments, the tensile storage modulus (E′) of (e.g. cured) polymer B at 25° C. and 1 Hertz is greater than 2 MPa, 3 MPa, 4 MPa, 5 MPa, or 6 MPa. In some embodiments, the tensile storage modulus (E′) at 25° C. and 1 Hertz is at least 1 × 10⁸ dynes/cm² (10 MPa), 1 × 10⁹ dynes/cm², 5 × 10⁹ dynes/cm², or 1 × 10¹⁰ dynes/cm² (i.e. 1000 MPa). Thus, polymer B of the second layer is not a pressure sensitive adhesive in accordance with the Dahlquist criteria.

In some embodiments, polymer B of the second layer has a Tg less than 30° C. and may be a heat bondable layer composition, such as described in International application no. PCT/US2015/064219. In other embodiments, polymer B of the second layer has a Tg of 30° C. or greater, such as described in International application no. PCTUS2015/064215.

In some embodiments, (e.g. cured) polymer B of the second layer generally has a tensile storage modulus (E′) at 120° C. of less than 9 × 10⁶ dynes/cm² (0.9 MPa) at 1 hertz as can be measure by dynamic mechanical analysis (as determined by the test method described in the examples). In some embodiments, (e.g. cured) polymer B of the second layer has a tensile storage modulus (E′) at 120° C. of less than 0.8, 0.7, 0.6, 0.5, or 0.4 MPa at 1 hertz. In some embodiments, e.g. cured) polymer B of the second layer has a tensile storage modulus (E′) at 120° C. of at least 0.3 or 0.4 MPa at 1 hertz.

In typical embodiments, polymer B of the second layer has flexural modulus less than about 1 GPa, or less than about 0.8 GPa, or less than about 0.25 GPa, or less than 0.1 GPa (i.e., typically having a modulus alone insufficient to move teeth absent the presence of layer(s) A and/or C). In some embodiments, the polymers B have an elongation at break of greater than about 300%, or greater than about 400%. In some embodiments, the ratio of elongation at break of polymers B to either of polymers A and C is no greater than about 5, or no greater than about 3.

In some embodiments, polymer B of the second layer comprises a (meth)acrylic polymer.

Polymer B of the second layer typically comprises polymerized units of one or more (meth)acrylate ester monomers derived from a (e.g. non-tertiary) alcohol containing 1 to 14 carbon atoms and preferably an average of 4 to 12 carbon atoms.

Examples of monomers include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol; 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, and the like.

Polymer B of the second layer typically comprises polymerized units of one or more low Tg (meth)acrylate monomers, i.e. a (meth)acrylate monomer that when reacted to form a homopolymer has a T_{g} no greater than 0° C. In some embodiments, the low Tg monomer has a T_{g} no greater than -5° C., or no greater than -10° C. The Tg of these homopolymers is often greater than or equal to -80° C., greater than or equal to -70° C., greater than or equal to -60° C., or greater than or equal to -50° C.

The low Tg monomer may have the formula H₂C=CR¹C(O)OR⁸, wherein R¹ is H or methyl and R⁸ is an alkyl with 1 to 22 carbons or a heteroalkyl with 2 to 20 carbons and 1 to 6 heteroatoms selected from oxygen or sulfur. The alkyl or heteroalkyl group can be linear, branched, cyclic, or a combination thereof.

Exemplary low Tg monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate. Low Tg heteroalkyl acrylate monomers include, but are not limited to, 2-methoxyethyl acrylate and 2-ethoxyethyl acrylate.

In some embodiments, polymer B of the second layer comprises polymerized units of at least one low Tg monomer(s) having an alkyl group with 6 to 20 carbon atoms. In some embodiments, the low Tg monomer has an alkyl group with 7 or 8 carbon atoms. Exemplary monomers include, but are not limited to, 2-ethylhexyl (meth)acrylate, isooctyl (meth)acrylate, n-octyl (meth)acrylate, 2-octyl (meth)acrylate, isodecyl (meth)acrylate,-and lauryl (meth)acrylate. In some embodiments, the monomer is an ester of (meth)acrylic acid with an alcohol derived from a renewable source, such as 2-octyl (meth)acrylate.

Polymer B of the second layer typically comprises at least 10, 15, 20 or 25 wt.-% of polymerized units of monofunctional alkyl (meth)acrylate low Tg monomer (e.g. having a Tg of less than 0° C.), based on the total weight of the polymerized units (i.e. excluding inorganic filler or other additives). As used herein, wt.-% of polymerized units refers to the wt.-% based on the total weight of the (meth)acrylic polymer, and other organic components such as polyvinyl acetal (e.g. butyral) polymer and crosslinker when present. Polymer B typically comprises no greater than 60, 55, 50, 45, or 40 wt.-% of polymerized units of monofunctional alkyl (meth)acrylate monomer having a Tg of less than 0° C., based on the total weight of the polymerized units.

In other embodiments, polymer B of the second layer comprises less than 10 wt.-% of polymerized units of monofunctional alkyl (meth)acrylate monomer having a Tg of less than 0° C. based on the total weight of the polymerized units of the (meth)acrylic polymer, polyvinyl acetal (e.g. butyral) polymer, and crosslinker when present. For example, the minimum concentration of polymerized units of monofunctional alkyl (meth)acrylate monomer having a Tg of less than 0° C. may be 0.5, 1, 2, 3, 4, 5, 6, 7, 8, or 9 wt.-%.

When polymer B of the second layer is free of unpolymerized components such as inorganic filler and additives, the wt.-% of specified polymerized units is approximately the same as the wt.-% of such polymerized units present in the total composition of the second layer. However, when polymer B comprises unpolymerized components, such as inorganic filler or other unpolymerizable additives the total composition can comprise substantially less polymerized units. In general, the total amount of unpolymerizable additives may range up to 25 wt.-%. Thus, in the case of second layers comprising such unpolymerizable additives the concentration of specified polymerized units can be as much as 5, 10, 15, 20, 25 wt.-% less, depending on the total concentration of such additives. For example, when the second layer comprises 20 wt.-% inorganic filler, the concentration of low Tg monofunctional alkyl (meth)acrylate monomer may be 20% less, i.e. at least 8 wt.-%, 12 wt.-%, etc.

Polymer B of the second layer generally comprises at least one (e.g. non-polar) high Tg monomer, i.e. a (meth)acrylate monomer when reacted to form a homopolymer has a Tg greater than 0° C. The high Tg monomer more typically has a Tg greater than 5° C., 10° C., 15° C., 20° C., 25° C., 30° C., 35° C., or 40° C.

In typical embodiments, polymer B of the second layer comprises at least one high Tg monofunctional alkyl (meth)acrylate monomers including for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, and propyl methacrylate or combinations.

In some embodiments, polymer B of the second layer comprises at least 1, 2, or 3 wt.-% up to 35, 40, 45, 50, 55, 60, 65 or 70 wt.-% of polymerized units of a monofunctional alkyl (meth)acrylate monomer having a Tg greater than 40° C., 50° C., 60° C., 70° C., or 80° C. based on the total weight of the polymerized units (i.e. excluding inorganic filler or other additives). In some embodiments, polymer B of the second layer comprises no greater than 30, 25, 20, or 10 wt.-% of polymerized units of high Tg monofunctional alkyl (meth)acrylate monomer. Further, in some embodiments, polymer B of the second layer comprises less than 1.0, 0.5, 0.1 wt.-% or is free of polymerized units of high Tg monofunctional alkyl (meth)acrylate monomer.

In other embodiments, polymer B of the second layer comprises greater than 40 wt.-% of polymerized units of a monofunctional alkyl (meth)acrylate monomer having a Tg greater than 40° C. based on the total weight of the polymerized units of the (meth)acrylic polymer and other organic components such as polyvinyl acetal (e.g. butyral) polymer and crosslinker when present. For example, the maximum concentration of polymerized units of a monofunctional alkyl (meth)acrylate monomer having a Tg greater than 40° C. may be 50, 60, 70, 80, or 90 wt.-%.

The Tg of the homopolymer of various monomers is known and is reported in various handbooks. The Tg of some illustrative monomers is also reported in WO 2016/094277, incorporated herein by reference.

In typical embodiments, polymer B of the second layer further comprises at least 10, 15 or 20 wt.-% and no greater than 65 wt.-% of polymerized units of polar monomers. Such polar monomers generally aid in compatibilizing the polyvinyl acetal (e.g. butyral) polymer with the high and low Tg alkyl (meth)acrylate solvent monomers. The polar monomers typically have a Tg greater than 0° C., yet the Tg may be less than the high Tg monofunctional alkyl (meth)acrylate monomer.

Representative polar monomers include for example acid-functional monomers, hydroxyl functional monomers, nitrogen-containing monomers, and combinations thereof.

In some embodiments, polymer B of the second layer comprises polymerized units of an acid functional monomer (a subset of high Tg monomers), where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

In some embodiments, polymer B of the second layer comprises 0.5 up to 20 or 25 wt.-% of polymerized units of acid functional monomers, such as acrylic acid. In some embodiments, polymer B of the second layer comprises at least 1, 2, 3, 4, or 5 wt.-% of polymerized units of acid-functional monomers. In other embodiments, the second layer comprises less than 1.0, 0.5, 0.1 wt.-% or is free of polymerized units of acid-functional monomers.

In some embodiments, polymer B of the second layer comprises non-acid-functional polar monomer.

One class of non-acid-functional polar monomers includes nitrogen-containing monomers. Representative examples include N-vinylpyrrolidone; N-vinylcaprolactam; acrylamide; mono- or di-N-alkyl substituted acrylamide; t-butyl acrylamide; dimethylaminoethyl acrylamide; and N-octyl acrylamide. In some embodiments, the second layer comprises at least 0.5, 1, 2, 3, 4, or 5 wt.-% of polymerized units of nitrogen-containing monomers and typically no greater than 25 or 30 wt.-%. In other embodiments, second layer comprises less than 1.0, 0.5, 0.1 wt.-% or is free of polymerized units of nitrogen-containing monomers.

Another class of non-acid-functional polar monomers includes alkoxy-functional (meth)acrylate monomers. Representative examples include 2-(2-ethoxyethoxy)ethyl (meth)acrylate, 2-ethoxyethyl (meth)acrylate, 2-hydroxyethyl (meth)acrylate, 2-(methoxyethoxy)ethyl, 2-methoxyethyl methacrylate, and polyethylene glycol mono(meth)acrylates.

In some embodiments, polymer B of the second layer comprises at least 0.5, 1, 2, 3, 4, or 5 wt.-% of polymerized units of alkoxy-functional (meth)acrylate monomers and typically no greater than 30 or 35 wt.-%. In other embodiments, the polymer B comprises less than 1.0, 0.5, 0.1 wt.-% or is free of polymerized units of alkoxy-functional (meth)acrylate monomers.

Preferred polar monomers include acrylic acid, 2-hydroxyethyl (meth)acrylate; N,N-dimethyl acrylamide and N-vinylpyrrolidinone. The second layer generally comprises polymerized units of polar monomer in an amount of at least 10, 15 or 20 wt.-% and typically no greater than 65, 60, 55, 50 or 45 wt.-%.

Polymer B of the second layer may optionally comprise vinyl monomers including vinyl esters (e.g., vinyl acetate and vinyl propionate), styrene, substituted styrene (e.g., α-methyl styrene), vinyl halide, and mixtures thereof. As used herein vinyl monomers are exclusive of polar monomers. In some embodiments, the second layer comprises at least 0.5, 1, 2, 3, 4, or 5 wt.-% and typically no greater than 10 wt.-% of polymerized units of vinyl monomers. In other embodiments, the second layer comprises less than 1.0, 0.5, 0.1 wt.-% or is free of polymerized units of vinyl monomers.

In some favored embodiments, the polymerized units of the (meth)acrylic polymer contain aliphatic groups and lack aromatic moieties.

In typical embodiments, the (e.g. solvent) monomer(s) are polymerized to form a random (meth)acrylic polymer copolymer.

In some embodiments, the kinds and amount of monomer can be selected to form a (meth)acrylic polymer having a Tg and/or crosslinking in the range previously described.

In some favored embodiments, polymer B of the second layer further comprises a polyvinyl acetal polymer. The polyvinyl acetal polymer may be obtained, for example, by reacting polyvinyl alcohol with aldehyde, as known in the art and described in greater detail in previously cited WO2016/094277. The polyacetal resin is typically a random copolymer. However, block copolymers and tapered block copolymers may provide similar benefits to random copolymers.

The content of polyvinyl acetal (e.g. butyral) typically ranges from 65 wt.-% up to 90 wt.-% of the polyvinyl acetal (e.g. butyral) polymer. In some embodiments, the content of polyvinyl acetal (e.g. butyral) ranges from about 70 or 75 up to 80 or 85 wt.-%. The content of polyvinyl alcohol typically ranges from about 10 to 30 wt.-% of the polyvinyl acetal (e.g. butyral) polymer. In some embodiments, the content of polyvinyl alcohol of the polyvinyl acetal (e.g. butyral) polymer ranges from about 15 to 25 wt.-%. The content of polyvinyl acetate of the polyvinyl acetal (e.g. butyral) polymer can be zero or range from 1 to 8 wt.-% of the polyvinyl acetal (e.g. butyral) polymer. In some embodiments, the content of polyvinyl acetate ranges from about 1 to 5 wt.-%.

In some embodiments, the alkyl residue of aldehyde comprises 1 to 7 carbon atoms. In other embodiments, the alkyl residue R₁ of the aldehyde comprises 3 to 7 carbon atoms such as in the case of butylaldehyde (R₁ = 3), hexylaldehyde (R₁ = 5), n-octylaldehyde (R₁ = 7). Of these, butylaldehyde, also known as butanal, is most commonly utilized. Polyvinyl butyral (“PVB”) polymer is commercially available from Kuraray under the trade designation “MOWITAL” and Solutia under the trade designation “BUTVAR”.

In some embodiments, the polyvinyl acetal (e.g. butyral) polymer has a Tg ranging from about 60° C. up to about 75° C. or 80° C., as measured by DSC. In some embodiments, the Tg of the polyvinyl acetal (e.g. butyral) polymer is at least 65 or 70° C. When other aldehydes, such as n-octyl aldehyde, are used in the preparation of the polyvinyl acetal polymer, the Tg may be less than 65° C. or 60° C. The Tg of the polyvinyl acetal polymer is typically at least 35, 40 or 45° C. When the polyvinyl acetal polymer has a Tg of less than 60° C., higher concentrations of high Tg monomers may be employed in polymer B of the second layer composition in comparison to those utilizing polyvinyl butyral polymer. When other aldehydes, such as acetaldehyde, are used in the preparation of the polyvinyl acetal polymer, the Tg may be greater than 75° C. or 80° C. When the polyvinyl acetal polymer has a Tg of greater than 70° C., higher concentrations of low Tg monomers may be employed in the second layer in comparison to those utilizing polyvinyl butyral polymer.

In some embodiments, the polyvinyl acetal (e.g. PVB) polymer typically has an average molecular weight (Mw) of at least 10,000 g/mole or 15,000 g/mole and no greater than 150,000 g/mole or 100,000 g/mole. In some favored embodiments, the polyacetal (e.g. PVB) polymer has an average molecular weight (Mw) of at least 20,000 g/mole; 25,000; 30,000, 35,000 g/mole and typically no greater than 75,000 g/mole.

In some embodiments, polymer B of the second layer comprises 5 to 30 wt.-% of polyvinyl acetal polymer such as polyvinyl butyral based on the total weight of the polymerized units of the (meth)acrylate polymer, polyvinyl acetal (e.g. butyral) polymer, and crosslinker when present. In some embodiments, the second layer comprises at least 10, 11, 12, 13, 14, or 15 wt.-% of polyvinyl acetal (e.g. PVB) polymer. In some embodiments, the second layer comprises no greater than 25 or 20 wt.-% of polyyinyl acetal (e.g. PVB) polymer. When the second layer comprises a polyvinyl acetal (e.g. PVB) polymer having an average molecular weight (Mw) less than 50,000 g/mole, the second layer may comprise higher concentration polyvinyl acetal (e.g. PVB) polymer such as 35 or 40 wt.-%. Thus, polymer B comprises a minor amount of polyvinyl acetal (e.g. PVB) resin in combination with a major amount of (meth)acrylic polymer. The amount of (meth)acrylic polymer is typically at least 50, 55, 60, 65, 70, 75, 80, 85, 90, or 95 wt.-% of polymer B of the second layer.

In other embodiments, polymer B of the second layer comprises less than 5 wt.-% of polyvinyl acetal (e.g. butyral) polymer based on the total weight of the polymerized units of the (meth)acrylic polymer, polyvinyl acetal (e.g. butyral) polymer, and crosslinker when present. For example, the minimum concentration of polyvinyl acetal (e.g. butyral) polymer may be 0.5, 1, 1.5, 2, 2.5, 3, 3.5, 4, or 4.5 wt.-%

In some favored embodiments, polymer B of the second layer comprises polymerized crosslinker units. In some embodiments, the crosslinker is a multifunctional crosslinker capable of crosslinking polymerized units of the (meth)acrylic polymer such as in the case of crosslinkers comprising functional groups selected from (meth)acrylate, vinyl, and alkenyl (e.g. C₃-C₂₀ olefin groups); as well as chlorinated triazine crosslinking compounds.

Examples of useful (e.g. aliphatic) multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof. One illustrative polyurethane di(meth)acrylate is commercially available from Sartomer as the trade designation CN996 (reported to have Tg of 8° C.)

In one embodiment, the crosslinking monomer comprises a (meth)acrylate group and an olefin group. The olefin group comprises at least one hydrocarbon unsaturation. The crosslinking monomer may have the formula

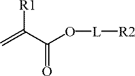

wherein R1 is H or CH₃, L is an optional linking group; and R2 is an olefin group, the olefin group being optionally substituted.

Dihydrocyclopentadienyl acrylate is one example of this class of crosslinking monomer. Other crosslinking monomers of this type comprising a C₆-C₂₀ olefin are described in WO 2014/172185.

In other embodiments, the crosslinking monomer comprises at least two terminal groups selected from allyl, methallyl, or combinations thereof. An allyl group has the structural formula H₂C=CH-CH₂-. It consists of a methylene bridge (—CH₂—) attached to a vinyl group (—CH═CH₂). Similarly, a methallyl group is a substituent with the structural formula H₂C=C(CH₃)-CH₂-. The terminology (meth)allyl includes both allyl and methallyl groups. Crosslinking monomers of this types are described in WO2015/157350.

In some embodiments, the second layer may comprise a multifunctional crosslinker comprising vinyl groups, such as in the case of 1,3-divinyl tetramethyl disiloxane.

The triazine crosslinking compound may have the formula

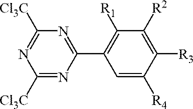

wherein R₁, R₂, R₃ and R₄ of this triazine crosslinking agent are independently hydrogen or alkoxy group, and 1 to 3 of R₁, R₂, R₃ and R₄ are hydrogen. The alkoxy groups typically have no greater than 12 carbon atoms. In favored embodiments, the alkoxy groups are independently methoxy or ethoxy. One representative species is 2,4,-bis(trichloromethyl)-6-(3,4-bis(methoxy)phenyl)-triazine. Such triazine crosslinking compounds are further described in U.S. 4,330,590.

In other embodiments, the crosslinker comprises hydroxyl-reactive groups, such as isocyanate groups, capable of crosslinking alkoxy group of the (meth)acrylic polymer (e.g. HEA) or polyvinyl alcohol groups of the polyvinyl acetal (PVB). Examples of useful (e.g. aliphatic) multifunctional isocyanate crosslinkers include hexamethylene diisocyanate, isophorone diisocyanate, as well as derivatives and prepolymers thereof.

Various combinations of two or more of crosslinkers may be employed.

When present, the crosslinker is typically present in an amount of at least 0.5, 1.0, 1.5, or 2 wt.-% ranging up to 5, 6, 7, 8, 9, or 10 wt.-% based on the total weight of the polymerized units of the (meth)acrylate polymer and other organic components, such as polyvinyl acetal (e.g. butyral) polymer and crosslinker. Thus, the second layer comprises such amount of polymerized crosslinker units.

In other embodiments, polymer B of the second layer comprises up to 25,30, 35, 40, 45, or 50 wt.-% polymerized crosslinker units. As the amount of crosslinker increases, the thickness of the Polymer B layer may decrease.

The molecular weight between crosslinks can be calculated from the following:

$${M}_{c} = \frac{3 R T d}{{{E}^{′}}_{\text{rubbery}}} ,$$

where R is the universal gas constant, T is temperature, d is the polymer density, and E′_{rubbry} is the tensile storage modulus as determined by Dynamic Mechanical Analysis according to the test method described in the examples.

In typical embodiments, molecular weight between crosslinks of Polymer B of the second layer is at least 500, 600, 700, 800, 900, 1000, 1100, 1200, 1300, 1400, or 1500 g/mole. In some embodiments, such as a dental appliance, the, molecular weight between crosslinks is typically greater than 1500, 1600, 1700, 1800, 1900, 2000, 2100, 2200, 2300, 2400 g/mole. The molecular weight between crosslinks is typically no greater than 20,000; 19,000; 18,000; 17,000; 16,000; 15,000; 14,000; 13,000; 12,000; 11,000; or 10,000 g/mole. In some embodiments, the molecular weight between crosslinks is typically no greater than 9000, 8000, 7000, 6000, 5000, 4000, 3000 g/mole. In some embodiments, the molecular weight between crosslinks is typically no greater than 2900, 2800, 2700, 2600, 2500, 2400, 2300, 2200, 2100, or 2000 g/mole. The molecular weight between crosslinks is a lower number when Polymer B is highly crosslinked. As evident by Comparative Example 2, when the molecular weight between crosslinks is too low, the presence of Polymer B can interfere with the capability to thermoform the multilayer film. However, highly crosslinked second layers of Polymer B may be suitable at reduced thicknesses such as less than 10, 9, 8, 7, 6, 5, 4, 3, 2, or 1 mil (1 mil = 25 microns).

In some embodiments, Polymer B of the second layer comprises sufficient crosslinking such that the second polymer layer lacks a thermal melt or softening transition at a temperature up to the decomposition temperature of the second polymer layer. Thus, in typical embodiments Polymer B of the second layer is sufficiently crosslinked such that Polymer B and the second layer are not thermoplastic.

In some embodiments, such as a dental appliance, the Tan Delta at 120° is less than 0.1, or 0.05, or 0. In some embodiments, the Tan Delta at 120° is less than -0.01, -0.02, -0.03. In some embodiments, the Tan Delta at 120° is greater than -0.11, -0.10, or -0.09.

Polymer B of the second layer can be polymerized by various techniques, yet is preferably polymerized by solventless radiation polymerization, including processes using electron beam, gamma, and especially ultraviolet light radiation. In this (e.g. ultraviolet light radiation) embodiment, generally little or no methacrylate monomers are utilized. Thus, polymer B of the second layer comprises zero or no greater than 10, 9, 8, 7, 6, 5, 4, 3, 2, or 1 wt.-% of polymerized units of monomer having a methacrylate group.

One method of preparing the polymer B of the second layer includes partially polymerizing the solvent monomer(s) to produce a syrup composition comprising a solute (meth)acrylic polymer dissolved in unpolymerized solvent monomer(s).

Another method comprises dissolving the polyvinyl acetal (e.g. PVB) polymer in the unpolymerized solvent monomer(s) of the (meth)acrylic polymer, forming a coatable composition of sufficient viscosity.

The polyvinyl acetal (e.g. PVB) polymer can be added prior to and/or after partial polymerization of monomer(s) of the (meth)acrylic polymer. In this embodiment, the coatable composition comprises partially polymerized (e.g. alkyl(meth)acrylate) solvent monomers and polyvinyl acetal (e.g. PVB) polymer. The coatable composition of Polymer B is then coated on a film or sheet (e.g. of polymer A or polymer C) or a release liner and further polymerized by exposure to radiation. By coating a film or sheet with the coatable solution of Polymer B, high interlayer adhesion can be obtained in the absence of primers or tie layers.

The viscosity of the coatable composition is typically at least 1,000 or 2,000 cps rangingup to 100,000 cps at 25° C. In some embodiments, the viscosity is no greater than 75,000; 50,000, or 25,000 cps.

The method can form a higher molecular weight (meth)acrylic polymer than can be used by solvent blending a prepolymerized (meth)acrylic polymer. Higher molecular weight (meth)acrylic polymer can increase the amount of chain entanglements, thus increasing cohesive strength. Also, the distance between crosslinks can be greater with a high molecular (meth)acrylic polymer, which allows for increased wet-out onto a surface of an adjacent (e.g. film) layer.

The molecular weight of polymer B of the second layer can be increased even further by the inclusion of crosslinker.

The polymer B of the second layer typically has a gel content (as measured according to the Gel Content Test Method described in the examples utilizing tetrahydrofuran (THF) of at least 20, 25 30, 35, or 40%. In some embodiments, the gel content is at least 45, 50, 55, 60, 65, 70, 75, 80, 85, 90, or 95%. The gel content is typically less than 100%, 99%, or 98%. When the (meth)acrylic polymer has a high gel content, it is typically not thermoplastic.

The polymerization is preferably conducted in the absence of unpolymerizable organic solvents such as ethyl acetate, toluene and tetrahydrofuran, which are non-reactive with the functional groups of the solvent monomer and polyvinyl (e.g. PVB) acetal when present. Solvents influence the rate of incorporation of different monomers in the polymer chain and generally lead to lower molecular weights as the polymers gel or precipitate from solution. Thus, polymer B of the second layer can be free of unpolymerizable organic solvent.

Useful photoinitiators include benzoin ethers such as benzoin methyl ether and benzoin isopropyl ether; substituted acetophenones such as 2,2-dimethoxy-2-phenylacetophenone photoinitiator, available under the trade name IRGACURE 651 or ESACURE KB-1 photoinitiator (Sartomer Co., West Chester, PA), and dimethylhydroxyacetophenone; substituted α-ketols such as 2- methyl-2-hydroxy propiophenone; aromatic sulfonyl chlorides such as 2-naphthalenesulfonyl chloride; photoactive oximes such as 1-phenyl-1,2-propanedione-2-(O-ethoxycarbonyl)oxime; mono- or bis- acrylphosphine oxides such as IRGANOX 819 or LUCIRIN TPO.

Preferred photoinitiators are photoactive compounds that undergo a Norrish I cleavage to generate free radicals that can initiate by addition to the acrylic double bonds. The photoinitiator can be added to the mixture to be coated after the polymer (e.g. syrup) has been formed, i.e., photoinitiator can be added. Such polymerizable photoinitiators are described, for example, in U.S. 5,902,836 and 5,506,279 (Gaddam et al.).

Such photoinitiators are typically present in an amount of from 0.1 to 1.0 wt.-%. Relatively thick coatings can be achieved when the extinction coefficient of the photoinitiator is low.

The second film layer composition can be coated on a film of polymer A or C or a release liner using conventional coating techniques. For example, these film compositions can be applied by methods such as roller coating, flow coating, dip coating, spin coating, spray coating knife coating, and die coating. Coating thicknesses may vary. The film composition may be of any desirable concentration for subsequent coating, but is typically 5 to 30, 35 or 40 wt.-% polyvinyl acetal polymer solids in (meth)acrylic solvent monomer. The desired concentration may be achieved by further dilution of the coatable composition. The coating thickness may vary depending on the desired thickness of the (e.g. radiation) cured second film layer.

The coated release liner may be brought in contact with a film of polymer A or C, prior to curing. Alternatively, the composition of the second layer may be cured prior to the second layer being disposed proximate the first layer.

The second layer composition and the photoinitiator may be irradiated with activating UV radiation having a UVA maximum in the range of 280 to 425 nanometers to polymerize the monomer component(s). UV light sources can be of various types. Low light intensity sources, such as blacklights, generally provide intensities ranging from 0.1 or 0.5 mW/cm² (millwatts per square centimeter) to 10 mW/cm² (as measured in accordance with procedures approved by the United States National Institute of Standards and Technology as, for example, with a UVIMAP UM 365 L-S radiometer manufactured by Electronic Instrumentation & Technology, Inc., in Sterling, VA). High light intensity sources generally provide intensities greater than 10, 15, or 20 mW/cm² ranging up to 450 mW/cm² or greater. In some embodiments, high intensity light sources provide intensities up to 500, 600, 700, 800, 900 or 1000 mW/cm². UV light to polymerize the monomer component(s) can be provided by various light sources such as light emitting diodes (LEDs), blacklights, medium pressure mercury lamps, etc., or a combination thereof. The monomer component(s) can also be polymerized with higher intensity light sources as available from Fusion UV Systems Inc., Gaithersburg, MD. The UV exposure time for polymerization and curing can vary depending on the intensity of the light source(s) used. For example, complete curing with a low intensity light course can be accomplished with an exposure time ranging from about 30 to 300 seconds, whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds.

The first and/or second layers may optionally contain one or more conventional additives. Additives include, for example, antioxidants, stabilizers, ultraviolet absorbers, lubricants, processing aids, antistatic agents, colorants, impact resistance aids, fillers, matting agents, flame retardants (e.g. zinc borate) and the like. Some examples of fillers or pigments include inorganic oxide materials such as zinc oxide, titanium dioxide, silica, carbon black, calcium carbonate, antimony trioxide, metal powders, mica, graphite, talc, ceramic microspheres, glass or polymeric beads or bubbles, fibers, starch and the like.

When present, the amount of additive can be at least 0.1, 0.2, 0.3, 0.4, or 0.5 wt.-%. In some embodiments, the amount of additive is no greater than 25, 20, 15, 10 or 5 wt.-% of the total first or second layer (i.e. total composition). In other embodiments, the concentration of additive can range up to 40, 45, 50, 55 or about 65 wt.-% of the total first or second layer.

In some embodiments, polymer B of the second layer is free of plasticizer, tackifier and combinations thereof. In other embodiments, polymer B of the second layer comprises plasticizer, tackifier and combinations thereof in amount no greater than 5, 4, 3, 2, or 1 wt.-% of the total second layer composition. From the standpoint of tensile strength, it is preferable not to add a large amount of tackifier or plasticizer.

Polymer B of the second layer can be characterized using various techniques. Although the Tg of a copolymer may be estimated by use of the Fox equation, based on the Tgs of the constituent monomers and the weight percent thereof, the Fox equation does not take into account interactions, such as incompatibility, that can cause the Tg to deviate from the calculated Tg. The Tg of Polymer B of the second layer refers to the Tg as measured by Dynamic Mechanical Analysis, according to the test method described in the examples. When polymer B of the second layer comprises polymerized units of a monomer having a Tg greater than 150° C., the upper limit of the DSC testing temperature is chosen to be higher than that of the highest Tg monomer. The midpoint Tg as measured by DSC is 10-12° C. lower than the peak temperature Tg as measured by Dynamic Mechanical Analysis (DMA) at a frequency of 10 Hz and a rate of 3° C./min. Thus, a Tg of 60° C. as measured according to DSC is equivalent to 70-72° C. when measured according to DMA as just described.

The Tg of polymer B of the second layer and is typically at least 20, 21, 22, 23, 24, 25, 26, 27, 28, 29, or 30° C. ranging up to 55, 60, 65, or 70° C. In some embodiments, the Tg of the second layer is no greater than 50 or 45° C. In some embodiments, the second layer exhibits a single Tg as measured by DSC.

A single Tg is one indication of a single (e.g. continuous) phase morphology. Thus, polymer B of the second layer can be characterized as a single (e.g. continuous) phase. Alternatively, polymer B or the second layer can be tested by transmission electron microscopy (TEM) according to the test method described in WO2016/094277. Single (e.g. continuous) phase morphology is preferred for films having low haze and high transmission.

In other embodiments, polymer B of the second layer can be characterized as having a dispersed phase of polyvinyl acetal (e.g. butyral) in a continuous phase of (meth)acrylic polymer. The average dispersion size can be calculated by averaging the diameter of randomly chosen particles (e.g. 100 particles) of the dispersed phase utilizing TEM. The average dispersion size can range from 0.1 to 10 microns. In some embodiments, the average dispersion size is less than 0.5, 0.4, 0.3, 0.2, or 0.1 microns.

An average dispersion size of less than 0.1 microns can also provide films having a low haze and high transmission.

The polymer B of the second layer can be characterized by tensile and elongation according to the test method described in previously cited in WO 2016/094277. In some embodiments, the tensile strength is at least 10, 11, 12, 13, 14 or 15 MPa and typically no greater than 50, 45, 40, or 35 MPa. The elongation at break can ranges from 2, 3, 4 or 5% up to about 150%, 200% or 300% and greater. In some embodiments, the elongation is at least 50, 100, 150, or 175% and may range up to 225, 250, 275, or 300%.

The second film layer is preferably non-tacky to the touch at room temperature (25° C.) and preferably at (e.g. storage or shipping) temperatures ranging up to (120° F.) 50° C. In some embodiments, the second layer may exhibit a low level of adhesion to glass. For example, the 180° peel values can be about 2 oz/inch or less at a 12 inch/minute peel rate.

In some embodiments, each of interior layers 290, 292 have a Tg of at least 5, 10, 15, 20, 25, or 30° C. and/or are crosslinked as previously described.

In other embodiments, a portion of interior layers 290, 292 have a Tg less than 0° C. by use for example of thermoplastic polymers described in International application no. PCT/IB2020/054051. For example, a portion of the interior layers may include thermoplastic polymers independently chosen from copolyester ether elastomers, copolymers of ethylene acrylates and methacrylates, ethylene methyl-acrylates, ethylene ethyl-acrylates, ethylene butyl acrylates, maleic anhydride modified polyolefin copolymers, methacrylic acid modified polyolefin copolymers, ethylene vinyl alcohol (EVA) polymers, styrenic block copolymers, ethylene propylene copolymers, and thermoplastic polyurethanes (TPU).

Suitable examples include materials available under the trade designation NEOSTAR such as, for example, FN007, and ECDEL from Eastman Chemical, ARNITEL co-polyester elastomer from DSM Engineering Materials (Troy, MI), RITEFLEX polyester elastomer from Celanese Corporation (Irvine TX), HYTREL polyester elastomer from DuPont, copolymers of ethylene and methyl acrylate available from Dow, Midland, MI under the trade designation ELVALOY, ethylene vinyl alcohol (EVA) polymers, and the like. Properties of suitable thermoplastic polymers are depicted as follows:

TABLE B

| | Tg | Tm | Vicat Softening Temp. | Flexural Modulus | Elongation at Break |
|---|---|---|---|---|---|
| TPU 65D | < 0° C. | N/R | 107° C. | 0.22 GPa | 450% |
| TEXIN | < 0° C. | N/R | 128° C. | 0.11 GPa | 480% |
| NEOSTAR | < 0° C. | 205° C. | 170° C. | 0.2 GPa | 400% |
| ECDEL | < 0° C. | 205° C. | 170° C. | 0.2 GPa | 400% |
| ELVALOY | < 0° C. | 101° C. | 70° C. | < 0.1 GPa | 740% |
| ADMER | < 0° C. | N/R | 40° C. | < 0.1 GPa | >200% |
| STPE | < 0° C. | N/R | N/A | < 0.1 GPa | >200% |

N/R = Not reported.

Such thermoplastic polymers having a Tg less than 0° C. typically have a flexural modulus less than about 0.24 GPa, or less than about 0.12 GPa. In some embodiments, such thermoplastic polymers has a solubility parameter ranging from 8 to 9 cal^{½}cm^{-3/2}. In some embodiments, such thermoplastic polymers has a solubility parameter ranging less than 8 cal^{½}cm^{-3/2}. In some embodiments, such thermoplastic polymers have an inherent viscosity greater than thermoplastic polymer A, e.g. of at least 1 cc/gm.

Referring again to FIG. 2, the polymeric shell 202 further includes additional optional performance enhancing layers that can be included to improve properties of the shell 202. Performance enhancing layers can be, for example, barrier layers that are resistant to staining and moisture absorption; abrasion-resistant layers; cosmetic layers that may optionally include a colorant, or may include a polymeric material selected to adjust the optical haze or visible light transparency of the polymeric shell 202; tie layers that enhance compatibility or adhesion between layers AB or BC, elastic layers to provide a softer mouth feel for the patient; thermal forming assistant layers to enhance thermoforming, layers to enhance mold release during thermoforming, and the like, as described for example in previously cited in International application no. PCT/IB2020/054051; incorporated herein by reference.

The performance enhancing layers may include a wide variety of polymers selected to provide a particular performance benefit, but the polymers in the performance enhancing layers are generally selected from materials that are softer and more elastic than the polymers ABC. In various embodiments, which are not intended to be limiting, the performance enhancing layers include thermoplastic polyurethanes (TPU) and olefins.

In some non-limiting examples, the olefins in the performance enhancing layers are chosen from polyethylene (PE), polypropylene (PP), polymethylpentene (PMP), cyclic olefins (COP), copolyolefins with moieties chosen from ethylene, propylene, butene, pentene, hexene, octene, C2-C20 hydrocarbon monomers with polymerizable double bonds, and mixtures and combinations thereof; and olefin hybrids chosen from olefin/anhydride, olefin/acid, olefin/styrene, olefin/acrylate, and mixtures and combinations thereof.

For example, in the embodiment of FIG. 2C, the polymeric shell 202 includes an optional moisture barrier layer 240 on each external surface, which can prevent moisture intrusion into the underlying polymeric layers and maintain for the shell 202 a substantially constant stress profile during a treatment time. The polymeric shell 202 further includes tie or thermoforming assist layers 250, which can be the same or different, between individual layers AB or BC. In some embodiments, the tie/thermoforming assist layers 250 can improve compatibility between the polymers in the layers AB or BC as the polymeric shell 202 is formed from a multilayered polymeric film, or reduce delamination between layers AB or BC and improve the durability, crack resistance, or teat strength of the polymeric shell 202 over an extended treatment time. The polymeric shell 202 in FIG. 2C further includes elastic layers 260, which can be the same or different, and can be included to improve the softness or mouth feel of the shell 202. In the embodiment of FIG. 2C, the elastic layers 260 are located proximal the major surfaces 220, 222 of the shell 202.

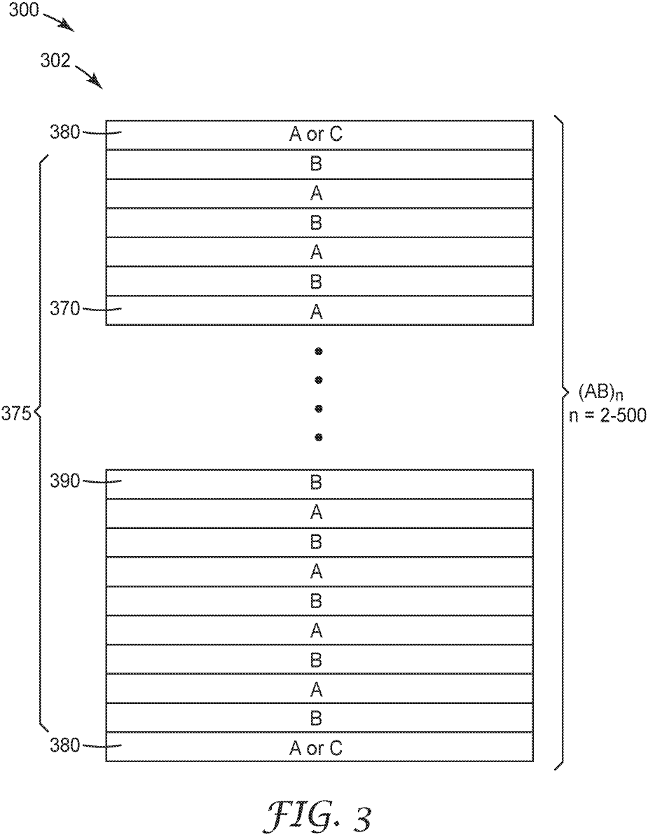

A schematic cross-sectional view of another embodiment of a dental appliance 300 is shown in FIG. 3, which includes a polymeric shell 302 with an interior region 375 having a multilayered polymeric structure (AB)ₙ, wherein n = 2 to about 500, or about 5 to about 200, or about 10 to about 100. The layers AB include core layers 370, 390 of the thermoplastic polymers A and B discussed above with respect to FIG. 2. The external layers 380 of the polymeric shell 302 can include one or more layers of either of the thermoplastic polymers A or C discussed above.

In some embodiments, any or all of the layers of the polymeric shell can optionally include dyes or pigments to provide a desired color that may be, for example, decorative or selected to improve the appearance of the teeth of the patient.

The orthodontic appliance 100 may be made using a wide variety of techniques. In one embodiment, a suitable configuration of tooth (or teeth)-retaining cavities are formed in a substantially flat sheet of a multilayered polymeric film that includes layers of polymeric material arranged like the configurations discussed described above with respect to FIGS. 1-3. In some embodiments, the multilayered polymeric film may be formed in a dispersion and cast into a film or applied on a mold with tooth-receiving cavities. In some embodiments, the multilayered polymeric film may be prepared by extrusion of multiple polymeric layer materials through an appropriate die to form the film. In some embodiments, a reactive extrusion process may be used in which one or more polymeric reaction products are loaded into the extruder to form one or more layers during the extrusion procedure.

In one embodiment, a method of thermoforming is described comprising providing a multilayer polymer film as described herein and thermoforming the multilayer polymer film into a three-dimensional shape. Thermoforming is a manufacturing process in which a thermoplastic sheet (also referred to as a film) is heated to a temperature where it becomes soft and flexible. Then the sheet is pressed into and stretched over a mold using air (both vacuum and compressed) pressure or pressed between molds using mechanical force to form it into the desired shape. The thermoforming process is usually segmented into thin-gauge (typically less than 5 mm) and thick-gauge markets. Thin gauge thermoforming as the name implies uses thin plastics and is used to manufacture rigid or disposable packaging items such as plastic cups, food containers, lids, or blisters, while thick gauge thermoforming is typically used to form more durable cosmetic permanent parts such as vehicle door inside panels and electronics packaging. In some embodiments, the multilayered polymeric film is heated prior to thermoforming, or a surface thereof may optionally be chemically treated such as, for example, by etching, or mechanically embossed by contacting the surface with a tool, prior to or after thermoforming. In one embodiment, the multilayer polymeric film is thermoformed into a dental appliance with tooth-retaining cavities.

The thermoformed (e.g. medical or packaging) article may optionally be crosslinked with radiation chosen from e-beam, gamma, UV, and mixtures and combinations thereof.

In various embodiments, the multilayer film and (e.g. medical or packaging) article is substantially optically clear. Some embodiments have a light transmission of at least about 50%. Some embodiments have a light transmission of at least about 75%. Some embodiments have a haze of no greater than 10%. Some embodiments have a haze of no greater than 5%. Some embodiments have a haze of no greater than 2.5%. Both the light transmission and the haze of the article can be determined using a HAZE-GARD PLUS meter available from BYK-Gardner Inc., Silver Springs, MD, which was designed to comply with the ASTM D1003-13 standard. The specimen surface is illuminated perpendicularly, with the transmitted light measured with an integrating sphere (0°/diffuse geometry). The spectral sensitivity conforms to CIE standard spectral value function “Y” under illuminant C with a 2° observer.

In other embodiments, the multilayer film or a (e.g. interior) layer thereof is opaque (e.g. white) or reflective.

In various embodiments, the multilayered polymeric film used to form the (e.g. medical or packaging) article or dental appliance has a thickness of less than about 1 mm, or less than about 0.8 mm, or less than about 0.5 mm. In some embodiments, the total thickness of the first layer or layers of polymer A is about equal to the total thickness of the second layer or layers of polymer B. In other embodiments, the total thickness of the first layer or layers of polymer A is greater than the total thickness of the second layer or layers of polymer B. In this embodiments, the thickness or weight ratio of polymer A to polymer B can be at least 2:1, 3:1, 4:1, 5:1, 6:1, or 7:1. In some embodiments, thickness or weight ratio of polymer A to polymer B is typically no greater than 10:1, 9:1, 8:1, 7:1, 6:1, 5:1, 4:1, or 3:1.

The (e.g. orthodontic) article 100 can exhibit a percent loss of relaxation modulus of 40% or less as determined by Dynamic Mechanical Analysis (DMA). The DMA procedure is described in detail in the Examples below. The loss is determined by comparing the initial relaxation modulus to the (e.g., 4 hour) relaxation modulus at 37° C. and 1% strain. It was discovered that orthodontic articles according to at least certain embodiments of the present disclosure exhibit a smaller loss in relaxation modulus than articles made of different materials. Preferably, an orthodontic article exhibits loss of relaxation modulus after hydration of 40% or less, 38% or less, 36% or less, 34% or even 32% or less. In some embodiments, the loss of relaxation modulus is at least 15%, 20%, or 25% or greater.

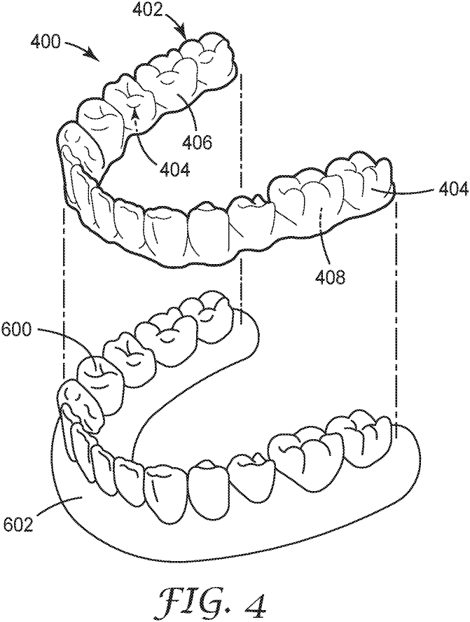

Referring now to FIG. 4, a shell 402 of an orthodontic appliance 400 includes an outer surface 406 and an inner surface 408 with cavities 404 that generally conform to one or more of a patient’s teeth 600. In some embodiments, the cavities 404 are slightly out of alignment with the patient’s initial tooth configuration, and in other embodiments the cavities 404 conform to the teeth of the patient to maintain a desired tooth configuration. In some embodiments, the shell 402 may be one of a group or a series of shells having substantially the same shape or mold, or incrementally different shapes, but which are formed from different polymeric materials, or different layers of polymeric materials, selected to provide a desired stiffness or resilience as needed to move the teeth of the patient. In some embodiments, the shell 402 may be one of a group or a series of shells having substantially the same shape or mold, or incrementally different shapes, but which are formed from the same polymeric materials, selected to provide a desired stiffness or resilience as needed to move the teeth of the patient. In this manner, in one embodiment, a patient or a user may alternately use one of the orthodontic appliances during each treatment stage depending upon the patient’s preferred usage time or desired treatment time period for each treatment stage.

No wires or other means may be provided for holding the shell 402 over the teeth 600, but in some embodiments, it may be desirable or necessary to provide individual anchors on teeth with corresponding receptacles or apertures in the shell 402 so that the shell 402 can apply a retentive or other directional orthodontic force on the tooth that would not be possible in the absence of such an anchor.

Referring again to FIG. 4, an orthodontic treatment system and method of orthodontic treatment includes applying to the teeth of a patient one or more incremental position adjustment appliances, each having substantially the same shape or mold, or incrementally different shapes. The incremental adjustment appliances may each be formed from the same or a different combination of polymeric materials, as needed for each treatment stage of orthodontic treatment. The orthodontic appliances may be configured to incrementally reposition individual or multiple teeth 600 in an upper or lower jaw 602 of a patient. In some embodiments, the cavities 404 are configured such that selected teeth will be repositioned, while other teeth will be designated as a base or anchor region for holding the repositioning appliance in place as the appliance applies the resilient repositioning force against the tooth or teeth intended to be repositioned.

### EXAMPLES

Flexural Modulus and Elongation at Break - The flexural modulus was tested according to ASTM D790-17 and tensile properties by ASTM D638-14. The specimen made by die cutting was placed in the grips of a universal testing machine. The stress-strain curve was then utilized to determine the modulus and elongation at break.

### Vicat Softening Temperature

Vicat softening temperature was measured according to ASTM D1525 - 17.

Melting Temperature and Glass Transition Temperature (of Polymers Reported in Tables A & B) Melting temperature and glass transition temperature were measured by DSC (differential scanning calorimeter) according to ASTM D3418.

Dynamic Mechanical Analysis for Determination of Tg and Tensile Storage Modulus (E′) Samples of cured Polymer B were cut into strips 6.35 mm wide and about 4 cm long. The thickness of each film was measured. The films were mounted in the tensile grips of a Q800 DMA from TA Instruments with an initial grip separation between 8 mm and 19 mm. In testing of total constructions, samples were tested at an oscillation of 0.2% strain and 1 Hz throughout a temperature ramp from -20° C. to 200° C. at a rate of 2° C. per minute. In testing of standalone films of polymer B, the temperature was then ramped from -50° C. to 150° C. at 2° C. per min while the sample was oscillated at a frequency of 1 Hertz and a constant strain of 0.1 percent.

Stress Relaxation by Dynamic Mechanical Analysis (DMA) - DMA rectangular specimens of the multilayer film were tested in a TA Instruments Q800 DMA (New Castle, DE). Samples were preconditioned in water for 24 hours prior to testing. The preconditioned samples were then tested by single cantilever bending in a DMA machine enclosed in an environmental chamber kept at 37° C. and 95% relative humidity. Stress relaxation was monitored after applying 1% strain and strain recovery was measured after the stress was removed. The testing time was about 4 hours. The stress relaxation is determined by comparing the initial relaxation modulus to the 4-hour relaxation modulus at 37° C. and 2% strain. The difference between initial modulus and final modulus was normalized to be the stress relaxation % reported in the examples.

Molecular Weight Between Crosslinks - Mc, the molecular weight between crosslinks was calculated from the following formula:

$${M}_{c} = \frac{3 R T d}{{{E}^{′}}_{\text{rubbery}}} ,$$

where R is the universal gas constant, T is temperature, d is the polymer density and E′_{rubbery} is the plateau tensile storage modulus.

Thermogravimetric Analysis: The decomposition temperature of Polymer B was measured by TGA. Approximately 17 to 25 milligrams of a sample was placed in a standard aluminum pan and heated to 400° C. . at a rate of 5° C. /min using a Model TGA 2950 ( TA Instruments, New Castle, Del ., USA). Decomposition temperature was measured at a weight loss of 50%.

Gel Content - Aluminum pans were weighed, and the weights (W1) were recorded. Mesh baskets were placed in pans and then weighed (basket and pan) and the weights (W2) were recorded. One inch (2.54 centimeter) diameter adhesive samples were placed into the baskets, and the samples (pan, basket, and adhesive sample) were weighed again (W3) and recorded. Samples (baskets and adhesive sample) were then placed in glass jars, covered with tetrahydrofuran, and left for three days. Then, the samples (basket and adhesive sample) were removed from tetrahydrofuran and placed back into pans. Samples (pan, basket, and adhesive samples) were placed in an oven at 120° C. for 2 hours. Sample were removed from the oven and allowed to cool. Subsequently, samples were weighed, and the weights (W4) were recorded. % Gel content = 100(W4-W2)/(W3-W2).

Tear Energy Test - Tear energy test was conducted according to ASTM-D624. The specimen made by Type B Specimen cutting die was placed in the grips of a universal testing machine at a grip distance of 2.25 inches. The testing rate was set at 500 mm/min. The stress-strain curve is then utilized to calculate the tear energy for breaking the specimen.

Procedure for Thermoforming and Temperature Measurement - The film was formed into an article on a BIOSTAR VI pressure molding machine (Scheu-Dental GmbH, Iserlohn, Germany). To thermoform, a 125 mm diameter piece of film obtained by die cutting was heated for 35 seconds and then pulled down over a rigid-polymer model. Maximum temperature of the film was measured using an IR thermometer (FLIR TG165, FLIR Systems, Inc., Wilsonville, OR) before pulling down over the rigid-polymer model. The BIOSTAR chamber behind the film was pressurized to 90 psi for 15 seconds of cooling time, after which the chamber was vented to ambient pressure and the formed article and arch model were removed from the instrument and cooled down to room temperature under ambient conditions.

TABLE 1

Materials Used in the Examples

| | |
|---|---|
| Designation | Description |
| EHA | 2-Ethylhexyl acrylate, available from BASF, Florham Park, NJ |
| AA | Acrylic acid, available from BASF, Florham Park, NJ |
| Irg 819 | Bis(2,4,6-trimethylbenzoyl)-phenylphosphineoxide, available under the trade designation IRGACURE 819 from BASF Corporation, Vandalia, IL |
| B60HH | Poly(vinyl butyral), available from Kuraray, Houston, TX, under the trade designation “MOWITAL B60HH” (Tg = 70° C.) |
| CN996 | An aliphatic polyester based urethane diacrylate oligomer available under the trade designation CN996 from Sartomer Americas, Exton, PA, |
| TRITAN film | 10 mil (0.254 mm) TRITAN film supplied from Pacur, Oshkosh, Wisconsin with a flexural modulus of 1.55 GPa |
| PETg | Copolyester from Eastman Chemicals, Kingsport, TN, grade: Eastar GN071 with a flexural modulus of 2.1 GPa |
| PCTg | Copolyester from Eastar GN071 from Eastman Chemicals, Kingsport, TN, grade: VM318 with a flexural modulus of 1.8 GPa |
| TEXIN | Thermoplastic polyurethane from Covestro, Pittsburgh, PA, grade RxT50D with a flexural modulus of 0.11 GPa |

Preparatory Examples - Preparatory Base Syrup 1: Base Syrup 1 was prepared by mixing the components in the amounts shown in Table 2 below as follows. Acrylic monomers and photoinitiator were combined in a 1-gallon (3.79 liters) glass jar and mixed using a high shear mixer to provide a homogeneous mixture. Next, B60HH was then added over a period of about three minutes with mixing. This was followed by further high-speed mixing until a homogeneous, viscous solution was obtained. This was then degassed for ten minutes at a vacuum of 9.9 inches (252 millimeters) of mercury. This base was used in the preparation of Formulations 1-4.

TABLE 2

Percentage and amounts used in preparation of Base Syrup 1

| | EHA | AA | Irg 819 | B60HH |
|---|---|---|---|---|
| Percentage | 66.5% | 16.6% | 0.2% | 16.6% |
| Grains Used | 1663.2 | 415.8 | 5.2 | 415.8 |

Formulations 1-4 were prepared by adding 100 g of Base Syrup 1 into a Speedmixer Cup along with crosslinker amounts shown in Table 3 and speed mixed in a Flacktec DAC 150.21 FVZ-K Speedmixer for 1 minute at 3,000 rpm.

TABLE 3

Film formulations 1-4

| | | Base 1 (g) | CN996 (g) |
|---|---|---|---|
| Comparative Example 1 | Formulation 1 | 100 | 0 |
| Example 1 | Formulation 2 | 100 | 2.5 |
| Example 2 | Formulation 3 | 100 | 5 |
| Comparative Example 2 | Formulation 4 | 100 | 10 |

Cured Polymer of Formulations 1-4 - The mixtures of Formulations 1-4 were two-roll coated at a thickness ranging from about 5 to 10 mils (0.13 to 0.25 mm) between PET release liners and cured by further exposure to UVA light. The resulting combination was exposed to a total UV-A energy of 1824 milliJoules/square centimeter using a plurality of fluorescent bulbs having a peak emission wavelength of 365 nanometers. The total UV-A energy was determined using a POWER PUCK II radiometer equipped with low power sensing head (available from EIT Incorporated, Sterling, VA) at a web speed of 4.6 meters/minute (15 feet/minute). The radiometer web speed and energy were then used to calculate the total exposure energy at the web speed used during curing of the acrylic composition. Physical properties of the cured polymer were tested as summarized in Table 5.

Examples 1-2 & Comparative Examples 1-2 - The mixtures of Formulations 1-4 were two-roll coated at a thickness ranging from about 5 to 10 mils (0.13 to 0.25 mm) between TRITAN films and cured by further exposure to UVA light. The resulting combination was exposed to a total UV-A energy of 1824 milliJoules/square centimeter using a plurality of fluorescent bulbs having a peak emission wavelength of 365 nanometers. The total UV-A energy was determined using a POWER PUCK II radiometer equipped with low power sensing head (available from EIT Incorporated, Sterling, VA) at a web speed of 4.6 meters/minute (15 feet/minute). The radiometer web speed and energy were then used to calculate the total exposure energy at the web speed used during curing of the acrylic composition. Stress relaxation behavior of the laminated films was tested by DMA. The films were thermoformed to assess their suitability for thermoforming into dental trays. The testing results are summarized in Table 4.

### Comparative Example 3

A single-layer polymeric film with 100% PET resin was extruded through a film die using a pilot scale extruder at a throughput of 15 lbs/hr (22.7 kg/hr). The extrusion melt temperature was controlled to be 520° F. (271° C.). The extruded sheet thickness was controlled at 30 mils (0.76 mm). Stress relaxation of PETg film was tested by DMA. PETg film was then thermoformed to assess its suitability for thermoforming into dental trays. As summarized in Table 4 below, PETG film is formable to dental trays by a thermoforming process, but its stress relaxation is greater than 40%.

### Comparative Example 4

A 3-layer ABA (PCTg/TEXIN/PCTg) film was extruded using a pilot scale coextrusion line equipped with a multi-manifold die. Two extruders were used for the skin layer (A) and fed with the first rigid resin, PCTg. The skin layer (A) extrusion melt temperatures were controlled at 520° F. (271° C.). The throughput was kept at 13.7 lbs/hr (6.2 kg/hr) from each extruder. The core layer (A) extruder was fed with a second thermoplastic polyurethane, TEXIN, and the extrusion melt temperature was controlled at 410° F. (210° C.). The core layer extrusion throughput was 13 lbs/hr (5.9 kg/hr). The extruded sheet was cast onto a chill roll. The overall sheet thickness was controlled at 30 mils (0.76 mm). The film was tested by DMA and thermoformed to assess its suitability for thermoforming into a dental tray. As summarized in Table 4 below, this 3-layer film is formable to dental tray by thermoforming process, but its stress relaxation is greater than 40%.

TABLE 4

| | DMA Stress Relaxation at 95% RH |
|---|---|
| Example 1 | 35.60% |
| Example 2 | 31.20% |
| Comparative Example 1 | 47.20% |
| Comparative Example 2 | 28.50% |
| Comparative Example 3 | 41.70% |
| Comparative Example 4 | 45.60% |

Properties of some of the polymeric materials used in the examples below are shown in Table 5 below.

TABLE 5A

Properties of Cured Polymer B Determined by Dynamic Mechanical Analysis

| | Tg | E′ @ 25° C. (Pa) | Tan δ @ 120° C. | E′ @ 120° C. (Pa) | Calculated (Mc, g/mol) |
|---|---|---|---|---|---|
| Comparative Example 1 | 38° C. | 6.6 × 10e7 | 0.05 | 594883 | 2505.4 |
| Example 1 | 38° C. | 5.5 × 10e7 | -0.03 | 469166 | 2213.5 |
| Example 2 | 37° C. | 5.0 × 10e7 | -0.08 | 411591 | 1982.5 |
| Comparative Example 2 | 37° C. | 4.9 × 10e7 | -0.11 | 362208 | 1543.1 |

10e7 = 10⁷

TABLE 5B

Properties of Cured Polymer B

| | Polymer Density (g/mL) | E′ @ 120° C. (Pa) | Calculated (Mc, g/mol) | Decomposition Temperature | Thermoformability |
|---|---|---|---|---|---|
| Comparative Example 1 | 0.93 | 594883 | 2505.4 | >350° C. | Good |
| Example 1 | 0.93 | 469166 | 2213.5 | >350° C. | Good |
| Example 2 | 0.93 | 411591 | 1982.5 | >350° C. | Good |
| Comparative Example 2 | 0.93 | 362208 | 1543.1 | >350° C. | Poor |

1. A method of thermoforming comprising
providing a multilayer polymer film comprising
a first thermoplastic polymer layer having a Tg greater than 60° C.; and
a second polymer layer disposed on the first thermoplastic polymer layer, optionally comprising a tie layer or primer layer between the first the second layers, wherein the second polymer layer is characterized by one or more properties selected from
i) a Tg ranging from 20 to 70° C.;
ii) a molecular weight between crosslinks of no greater than 20,000 g/mole; and
iii) sufficient crosslinking such that the second polymer layer lacks a thermal melting or softening transition at temperatures up to the decomposition temperature of the second polymer layer; and
thermoforming the multilayer polymer film into a three-dimensional shape.

2. The method of claim 1 wherein the first thermoplastic polymer layer has a melting or softening temperature in a range from 70° C. to 140° C.

3. The method of claim 1 wherein the first thermoplastic polymer layer is a polyester, polyolefin, or polyamide material.

4. The method of claim 1 wherein the first thermoplastic polymer layer is selected from the group consisting of polyethylene terephthalate (PET), polyethylene terephthalate glycol (PETg), polycyclohexylenedimethylene terephthalate (PCT), polycyclohexylenedimethylene terephthalate glycol (PCTg), poly(1,4 cyclohexylenedirnethylene) terephthalate (PCTA), 2,2,4,4-tetramethyl-1,3-cyclobutanediol modified polycyclohexylenedimethylene terephthalate.

5. The method of claim 1 wherein the second polymer layer has a tensile elastic modulus of at least 1 MPa at 25° C. and 1 hertz.

6. The method of claim 1 wherein the second polymer layer comprises a (meth)acrylic polymer.

7. The method of claim 6 wherein the second polymer layer further comprise a polyvinyl acetal resin.

8. The method of claim 7 wherein the polyvinyl acetal resin comprises polymerized units having the formula 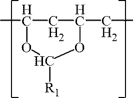
wherein R₁ is hydrogen or a C1-C7 alkyl group.

9. The method of claim 1 wherein the second polymer layer further comprises at least 10, 15, 20 or 25 wt.% of polymerized units of monofunctional alkyl (meth)acrylate monomer having a Tg of less than 0° C.

10. The method of claim 9 wherein the monofunctional alkyl (meth)acrylate monomer has a Tg of less than -10° C., -20° C., -30° C., or -40° C.

11. (canceled)

12. The method of claim 1 wherein the second polymer layer further comprises up to 35 wt.% of polymerized units of a monofunctional alkyl (meth)acrylate monomer having a Tg greater than 40° C., 50° C., 60° C., 70° C., or 80° C.

13. The method of claim 1 wherein the second polymer layer comprises at least 5, 10, or 15 wt.% of polymerized units of polar monomers.

14. The method of claim 13 wherein the polar monomers are selected from acid-functional, hydroxyl functional monomers, nitrogen-containing monomers, and combinations thereof.

15. The method of claim 1 wherein the second polymer layer comprises 5 to 30 wt-% of polyvinyl acetal resin.

16. The method of claim 1 wherein the second polymer layer comprises polyvinyl butyral.

17. The method of claim 1 wherein the second polymer layer has a single Tg.

18. The method of claim 1 wherein the first thermoplastic polymer has a flexural modulus greater than 1.3 GPa and the multilayer polymer film has an effective modulus of about 0.8 GPa to about 1.5 GPa.

19. The method of claim 1 wherein the article is a dental appliance for positioning a patient’s teeth.

20. The method of claim 1 wherein the multilayer film has a stress relaxation of less than 40, 35, 30, at 37° C. and 95% relative humidity.

21-22. (canceled)

23. An article comprising a thermoformed polymer film comprising at least two layers wherein
a first thermoplastic polymer layer has a Tg greater than 60° C.; and
a second polymer layer is characterized by one or more properties selected from
i) a Tg ranging from 20 to 70° C.;
ii) a molecular weight between crosslinks of no greater than 20,000 g/mole; and
iii) sufficient crosslinking such that the second polymer layer lacks a thermal melting or softening transition at temperatures up to the decomposition temperature of the second polymer layer.

24-30. (canceled)
